(19) United States
(12) Patent Application Publication
(10) Pub. No.: US 2015/0194045 A1
(43) Pub. Date: Jul. 9, 2015

(54) Devices and methods for generating gunshot alerts

(71) Applicants: David A. Edwards, Queen Creek, AZ (US); Narciso Macia, Queen Creek, AZ (US)

(72) Inventors: David A. Edwards, Queen Creek, AZ (US); Narciso Macia, Queen Creek, AZ (US)

(21) Appl. No.: 13/589,887

(22) Filed: Aug. 20, 2012

Related U.S. Application Data
(60) Provisional application No. 61/524,796, filed on Aug. 18, 2011.

(51) Int. Cl. G08B 25/10

(52) U.S. Cl. CPC G08B 25/10

(57) ABSTRACT

Devices and methods for generating gunshot alerts are provided. In some embodiments, devices for generating a gunshot alert are provided, the devices comprising: a microphone having an output; an amplifier having an input coupled to the output of the microphone and an output; a band-pass filter having an input coupled to the output of the amplifier and an output; an analog to digital converter having an input coupled to the output of the band-pass filter and an output; a microcontroller having an input coupled to the output of the analog to digital converter and an output; and a notification device having an input coupled to the output of the microcontroller.

### CROSS-REFERENCE TO RELATED APPLICATION

This application claims the benefit of U.S. Provisional Patent Application No. 61/524,796, filed Aug. 18, 2011, which is hereby incorporated by reference herein in its entirety.

### TECHNICAL FIELD

Devices and methods for generating gunshot alerts are provided.

### BACKGROUND

Each year, more people tend to be tragically injured or killed by active shooters who move from victim to victim. An active shooter is someone who, in a relatively limited area, has already implemented deadly force and who appears likely to continue to use deadly force in an attempt to kill additional people. Usually, this takes place indoors, in a single room, or in multiple rooms, and sometimes in multiple buildings. It is essential that an active shooter's actions be terminated as quickly as possible. The faster that an active shooter can be stopped, the more lives are saved and the fewer people are wounded.

The setting in which an active shooting incident takes place may be any of a number of different venues. The venues, for example, may be educational, with incidents taking place on a high school, trade-school, community college, four-year college or university campus. Numbers of victims shot per year in such educational venues appear to be growing exponentially over time.

Active shooters may alternatively choose for perpetrating their crimes a non-educational venue: e.g., a shopping center, a mall, a museum, a court of justice, a military base or some other public, private or government venue. The National Retail Federation lists 18 active shooter incidents at U.S. retail establishment, for example, between 2004 and 2008. One of these incidents took place in 2004, two took place in 2005, two in 2006, five in 2007, and eight in 2008. Again, these numbers indicate a growing problem.

Once an active shooter begins shooting, delays before effective law enforcement personnel arrive may add substantially to the count of victims. Law enforcement dispatchers therefore need a rapid, automatic means of receiving notification of the locations of indoor gunshot events. When law enforcement and school officials are notified immediately after a gunshot, they are better able to take prompt action, thereby enhancing the likelihood of fewer casualties.

### SUMMARY

Devices and methods for generating gunshot alerts are provided. In some embodiments, devices for generating a gunshot alert are provided, the devices comprising: a microphone having an output; an amplifier having an input coupled to the output of the microphone and an output; a band-pass filter having an input coupled to the output of the amplifier and an output; an analog to digital converter having an input coupled to the output of the band-pass filter and an output; a microcontroller having an input coupled to the output of the analog to digital converter and an output; and a notification device having an input coupled to the output of the microcontroller.

In some embodiments, methods for generating a gunshot alert are provided, the methods comprising: detecting sounds using a microphone that produces a microphone output signal; amplifying the microphone output signal to provide an amplified signal; performing band-pass filtering at a first frequency on the amplified signal to produce a band-pass filtered signal; performing envelope detection on the band-pass filtered signal to produce an envelope detection signal; performing an analog to digital conversion on the envelope detection signal to produce a digital signal; determining when the digital signal represents a gunshot and producing an alert signal when the digital signal is determined to represent a gunshot; and generating a gunshot alert when the alert signal is produced.

### BRIEF DESCRIPTION OF THE DRAWINGS

FIG. 1 is a block diagram of a device for generating gunshot alerts in accordance with some embodiments.

FIG. 2 is a block diagram of another device for generating gunshot alerts in accordance with some embodiments.

FIG. 3 is an illustration of a signal detected in response to a gunshot in accordance with some embodiments.

FIG. 4 is an example of a schematic of a portion of a device in accordance with some embodiments.

### DETAILED DESCRIPTION

Devices and methods for generating gunshot alerts are provided. In some embodiments, a device includes a microphone, an amplifier, one or more narrow-bandpass filters each in combination with an envelope detector, and a microcontroller to collectively detect an amplified analog signal in one or more specific frequency ranges above a pre-determined amplitude that lasts longer than a specified duration, corresponding to pre-identified signal characteristics of a gunshot in a room, and to convert the analog signal to a digital signal, which can then be used to activate a communications device to send information about the location of the gunshot to proper authorities (e.g., a 911 call center).

In some embodiments, a device can be implemented as a simple, inexpensive device designed to detect a gunshot in a room and provide nearly immediate notification of the gunshot location to one or more authorities (e.g., a dispatcher at 911 call center). This notification may be in the form of a pre-recorded audio recording, a pre-scripted digital text or some other form of communication that includes critical location information such as the city, the campus or facility, the building, the room number, the global positioning system (GPS) coordinates, and/or any other suitable data. Such a device can be designed to help save lives and protect the health and wellbeing of those remaining in a room and those in nearby areas after an initial shot has been fired in the room by one or more active shooters.

In some embodiments, such a device can be used in college or university campuses, high school grounds, shopping centers, malls, industrial facilities, military bases, and/or any other suitable area where there is concern that an active shooter may roam and act with lethal force with the intent to kill.

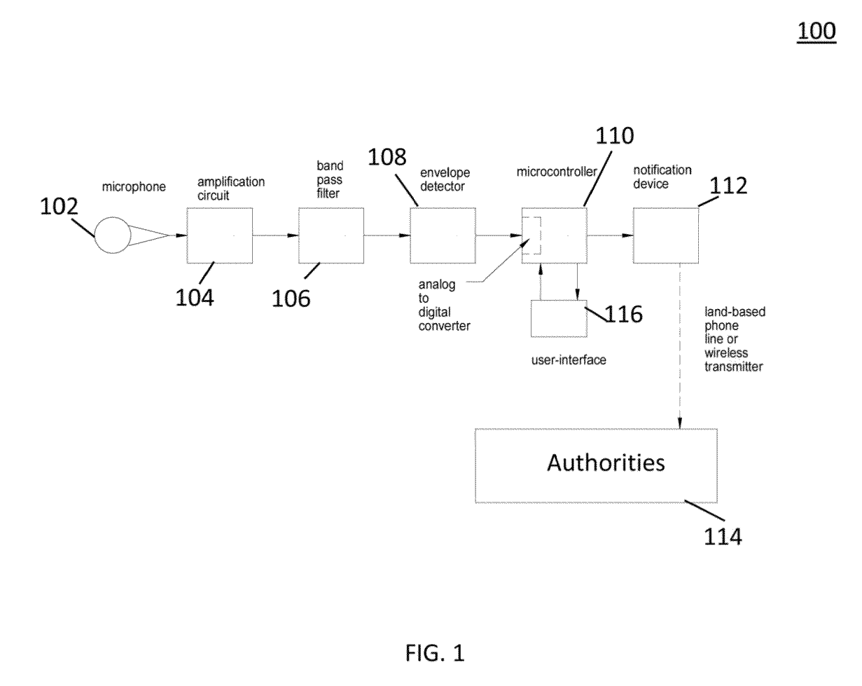

Turning to FIG. 1, an example of a device 100 for detecting a gun shot and generating an alert in accordance with some embodiments is shown. As illustrated, device 100 can include a microphone 102, an amplification circuit 104, one or more band-pass filters 106, one or more envelope detectors 108, a microcontroller 110, and a notification device 112.

In some embodiments, microphone 102 can be any suitable microphone or other sound sensor for detecting the audio signal produced by a gunshot.

Amplifier 104 can be any suitable amplifier for strengthening a sound signal produced by the microphone.

Band-pass filter(s) 106 can be any suitable filter(s) that, either individually or in parallel (or collectively), allow only one or more specified components of a sound signal, within one or more specified frequency bands, to pass.

Envelope detector(s) 108 can be any suitable envelope detector(s) (or peak detector(s) implemented as an envelope detector). An envelope detector 108 can be provided for each band-pass filter. The envelope detector(s) can provide an envelope for all positive parts of the signal output from the band-pass filter(s).

Microcontroller 110 can be any suitable hardware processor, such as a microcontroller, a microprocessor, a digital signal processor, a field programmable gate array (FPGA), etc. for processing the signal produced by the envelope detector(s). In some embodiments, the microcontroller can be equipped with one or more analog-to-digital converters that convert an analog signal from the envelope detector(s) into digital signals. In some embodiments, one or more separate analog to digital converters can be provided, and any suitable analog to digital converters, with any suitable input ranges and sampling rates, can be used. The analog to digital converters analyze the output of each envelope detector and convert it into a digital representation.

In some embodiments, decision logic, implemented in microcontroller 110, can assess the persistence and duration of the signals produced by the envelope detector(s) within one or more specified narrow-band ranges. Based on this, the microcontroller can send an electrical signal that triggers notification circuitry 112 when the signals within the one or more specified narrow-band ranges persist at or above a pre-determined level longer than a specified duration, corresponding with identified gunshot sound characteristics, and when, optionally, the signals are not identified as being at or above a pre-determined level within one or more other specified narrow-band ranges that are not found to be associated with gunshots. Such decision logic can be implemented via dedicated hardware logic, software, and/or any other suitable mechanism.

Notification circuitry 112 can be any suitable mechanism for alerting authorities 114 to a gunshot. For example, circuitry 112 can send a notification over a landline, a cellular (mobile) telephone network, one or more pager frequencies, a wired network, a wireless network, a telephone network, a cable network, a satellite network, the Internet, a local area network, a wide area network, and/or any other suitable communication network. As another example, notification circuitry 112 can deliver a notification to proper authorities (e.g., administrators, 911 call center dispatchers, security officers, police, military, etc.) providing them with any suitable information (e.g., the relevant municipality, campus, facility, building name or number, room number, approximate geographical coordinates, number of gunshots, time since first gunshot, sound intensity of gunshot, duration of gunshot sound, the type of gun used, etc.). Such a notification may, for example, be provided in the form of a pre-recorded audio message, a pre-scripted text message, a video signal, a data signal, and/or any other suitable form of communication.

In some embodiments, for example, notification device 112 can be implemented as a commercial auto-dialer for a landline. Such a device can rely on receiving a simple change in voltage on a single input wire to initiate two phone calls in series involving messages in which building and room information is pre-recorded for a particular device.

In some embodiments, equipment at the location of authorities can perform any suitable processing on any received notification or no processing at all. For example, in some embodiments, equipment can simply be a monitor displaying the time(s) and location of the event. As another example, the equipment can analyze the received information, and make a prediction regarding the behavior of the assaulter. As yet another example, the equipment can propose a suitable response scenario. As still another example, the equipment can simply play notification audio to a responder.

In some embodiments, a user interface 116 can also be provided for configuring the device. For example, in some embodiments, the interface can be a touch screen display, can be a data port (e.g., such as an ethernet port, a serial port, a USB port, etc.), etc.

In some embodiments, additional circuitry (not shown) can be provided that activates video cameras, microphones for additional sound monitoring, two-way communications portals, alarms or other devices. Additionally or alternatively, in some embodiments, thermal sensors and/or infrared light detectors can be provided to detect data relating to changes in temperature, and the device can use that data to confirm gunshots, help distinguish non-gunshot events (like explosions, objects bursting in fires, etc.), and provide corresponding information to authorities.

In some embodiments, gunshots can also be screened based, not only upon the presence of signals of specified duration in one or more frequency bands, but also upon the absence of signals of specified duration in one or more additional frequency bands.

In some embodiments, power for such a device can be provided from any suitable source. For example, a power supply for the device can be plugged into an electrical wall or ceiling outlet, the device can be battery or solar powered, the device can be powered via a communication network (e.g., power over ethernet), the device can be powered by an alarm system, etc.

In some embodiments, the device can be hidden or mounted in a secure structure in order to prevent it from being disabled.

In some embodiments, additionally or alternatively to gunshot detection and notification, alternative configurations of the device can be utilized to detect other types of sounds and provide notification. For example, such a device can be used in some embodiments to monitor specific sounds associated with rockets, engines, tank treads, and/or any other suitable sounds.

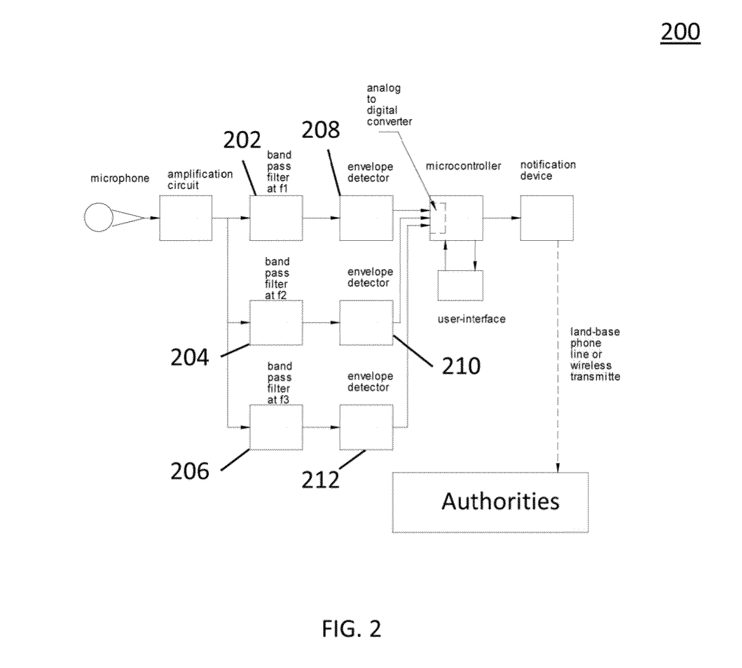

As described above, in some embodiments, multiple band-pass filters and multiple envelope detectors can be used. An example of such an embodiment is illustrated in FIG. 2 as device 200. As shown, this device can include three filters 202, 204, and 206 at respective frequencies f1, f2, and f3. Corresponding envelope detectors 208, 210, and 212 can also be provided. This approach can allow more selectivity, by demanding the signal to have certain frequency components, and not have others.

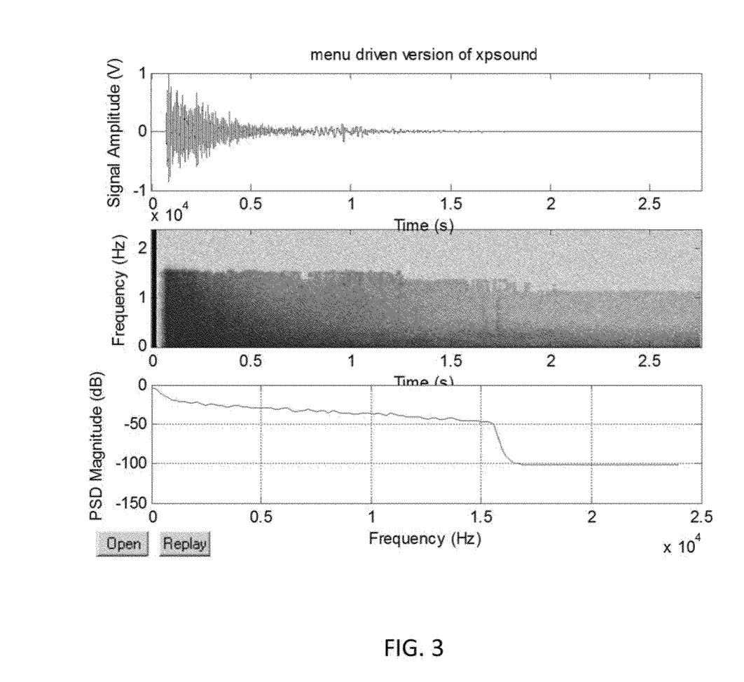

An example of a signal detected in response to a gunshot is shown in FIG. 3. Accordingly, in some embodiments, a gunshot can be detected in an audio signal having a series of tones around 2 kHz (or any other suitable frequency or combination of frequencies), a persistence of these tones for more than 0.5 seconds (or any other suitable duration or combination of durations), and, optionally in some embodiments, a decay in the intensity of the tones (which can be used to distinguish non-shooting sounds).

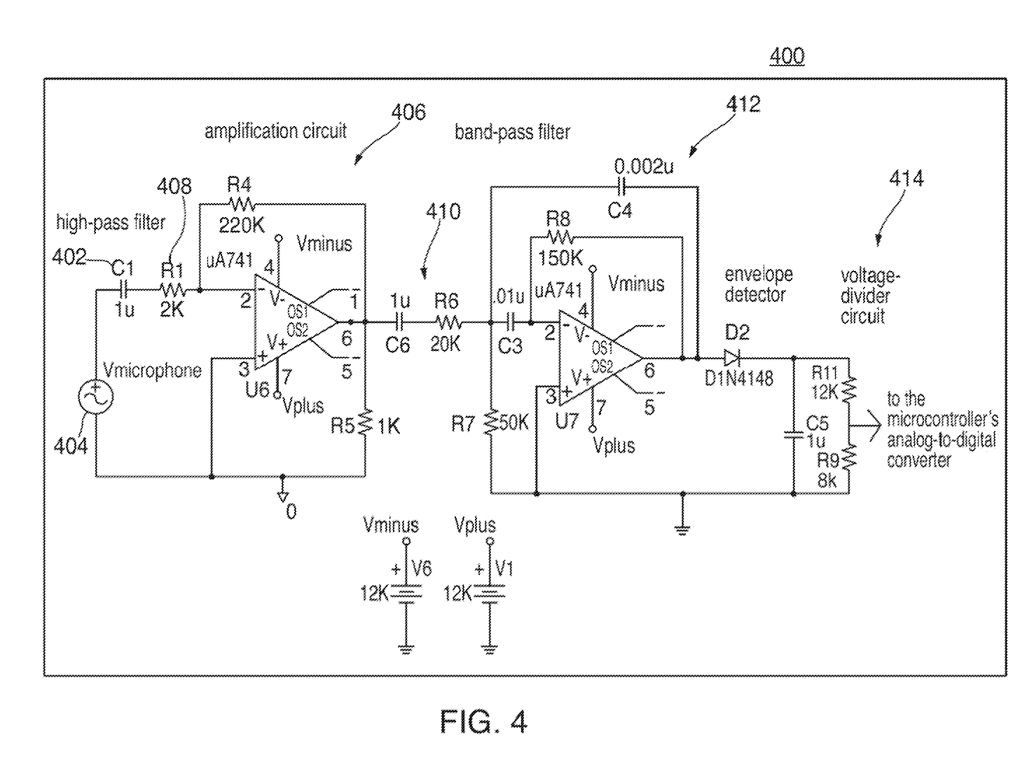

Turning to FIG. 4, an example of a schematic for implementing some embodiments is illustrated. As shown, in some embodiments, a capacitor 402 can be used to AC-couple the output of a microphone 404 to an amplifier 406. This capacitor in conjunction with a resistor 408 can produce a high-pass filter that only allows an AC component of the signal to pass through. A band-pass filter 410 with a window of around 2000 Hz can be provided. An envelope detector 412 can be implemented using a peak detector that produces a smoother signal that “envelops” all the positive peaks of the signal. In some embodiments, the envelope detector can also incorporate a voltage-divider circuit 414 to adjust the amplitude of the signal provided to the microcontroller. In some embodiments, instead of using a voltage divider, an amplification circuit can be used to adjust the signal for input into the microcontroller.

In some embodiments, any suitable hardware can be used to provide one or more portions of the components and functions described above, and such hardware can be implemented in one or more general purpose devices such as a computer or a special purpose device such as a client, a server, etc. Any of these general or special purpose devices can include any suitable components such as a hardware processor (which can be a microprocessor, digital signal processor, a microcontroller, etc.), memory, communication interfaces, display controllers, input devices, etc., and can be configured to operate in response to software instructions consistent with the functionality described herein.

In some embodiments, any suitable computer readable media can be used for storing instructions for performing the processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Although the invention has been described and illustrated in the foregoing illustrative embodiments, it is understood that the present disclosure has been made only by way of example, and that numerous changes in the details of implementation of the invention can be made without departing from the spirit and scope of the invention, which is only limited by the claims which follow. Features of the disclosed embodiments can be combined and rearranged in various ways.

What is claimed is:

1. A device for generating a gunshot alert, comprising:
a microphone having an output;
an amplifier having an input coupled to the output of the microphone and an output;
a band-pass filter having an input coupled to the output of the amplifier and an output;
an envelope detector having an input coupled to the output of the band-pass filter and an output;
an analog to digital converter having an input coupled to the output of the envelope detector and an output;
a microcontroller having an input coupled to the output of the analog to digital converter and an output; and
a notification device having an input coupled to the output of the microcontroller.

2. The device of claim 1, wherein the analog to digital converter and the microcontroller are integrated.

3. The device of claim 1, wherein the band-pass filter passes 2 kHz.

4. The device of claim 1, wherein the notification device is a commercial auto-dialer.

5. The device of claim 1, wherein the notification device sends a notification via a computer network.

6. The device of claim 1, wherein the notification device sends a notification via a cellular telephone network.

7. The device of claim 1, wherein the notification device sends a notification via a wireless network.

8. The device of claim 1, further comprising a user interface.

9. The device of claim 1, further comprising another band-pass filter and another envelope detector.

10. The device of claim 1, wherein the microcontroller detects a gunshot based on the presence of signals of specified duration in one or more frequency bands.

11. The device of claim 1, wherein the microcontroller detects a gunshot based on the presence of signals of specified duration in one or more frequency bands and on the absence of signals of specified duration in one or more additional frequency bands.

12. A method for generating a gunshot alert, comprising:
detecting sounds using a microphone that produces a microphone output signal;
amplifying the microphone output signal to provide an amplified signal;
performing band-pass filtering at a first frequency on the amplified signal to produce a band-pass filtered signal;
performing envelope detection on the band-pass filtered signal to produce an envelope detection signal;
performing an analog to digital conversion on the envelope detection signal to produce a digital signal;
determining when the digital signal represents a gunshot and producing an alert signal when the digital signal is determined to represent a gunshot; and
generating a gunshot alert when the alert signal is produced.

13. The method of claim 12, wherein the first frequency is 2 kHz.

14. The method of claim 12, wherein the gunshot alert is generated using a commercial auto-dialer.

15. The method of claim 12, wherein the gunshot alert is communicated using a computer network.

16. The method of claim 12, wherein the gunshot alert is communicated using a cellular telephone network.

17. The method of claim 12, wherein the gunshot alert is communicated using a wireless network.

18. The method of claim 12, further comprising receiving configuration settings via a user interface.

19. The method of claim 12, further comprising:
performing band-pass filtering at a second frequency on the amplified signal to produce a second band-pass filtered signal; and
performing envelope detection on the second band-pass filtered signal to produce an second envelope detection signal.

20. The method of claim 12, wherein the determining when the digital signal represents a gunshot comprises detecting a gunshot based on the presence of signals of specified duration in one or more frequency bands.

21. The method of claim 12, wherein the determining when the digital signal represents a gunshot comprises detecting a gunshot based on the presence of signals of specified duration in one or more frequency bands and on the absence of signals of specified duration in one or more additional frequency bands.
